(19) United States
(12) Patent Application Publication
(10) Pub. No.: US 2011/0052179 A1
(43) Pub. Date: Mar. 3, 2011

(54) MOUNTING DEVICE FOR SECURITY CAMERA

(75) Inventors: Kyung Jung, Seoul (KR); Na Young Kang, Incheon (KR)

(73) Assignee: POWERTECH ELECTRONICS, Incheon (KR)

(21) Appl. No.: 12/829,798

(22) Filed: Jul. 2, 2010

(30) Foreign Application Priority Data
Aug. 27, 2009 (KR) 10-2009-0079936

(51) Int. Cl. G03B 17/00

(52) U.S. Cl. 396/427

(57) ABSTRACT

Disclosed herein is a mounting device for a security camera. In the mounting device, a mounting plate means is fastened and then a cover means is fitted into the mounting plate means when the security camera is mounted to a building, thus enabling easy and convenient installation. The mounting device includes a mounting plate means and a cover means. The mounting plate means includes a mounting plate having a plurality of mounting holes at regular intervals to mount the mounting plate means to a wall, and a pocket part integrally provided on a predetermined portion of the mounting plate and having an insert space. The cover means includes a body having on a central portion thereof a coupling sleeve, with a camera coupling means being coupled to the coupling sleeve. An insert part is integrally provided on the body and fitted into the insert space.

### CROSS-REFERENCE TO RELATED APPLICATION

This application claims under 35 U.S.C. §119(a) the benefit of Korean Application No. 10-2009-0079936 filed on Aug. 27, 2009, the entire contents of which are incorporated herein by reference.

### BACKGROUND OF THE INVENTION

1. Field of the Invention

The present invention relates generally to mounting devices for security cameras and, more particularly, to a mounting device for a security camera, wherein a mounting plate means is first fastened and then a cover means is fitted into the mounting plate means when the security camera is mounted to the wall or ceiling of a building, thus enabling the security camera to be easily and conveniently mounted.

2. Description of the Related Art

Generally, security cameras (including CCTV cameras) are installed for surveillance in specific places and then used to monitor images from a remote place. These security cameras are mainly installed in or outside areas that may need surveillance such as offices, houses, hospitals, banks, and public establishments and are used to control people's entry or prevent crimes. In recent years, the installation of the security cameras is increasing in underground parking lots where the number of crimes is on the rise, roads for illegal parking control, or residential areas where various accidents frequently take place.

In order to meet the purpose of the security cameras, the security cameras must be mounted in a position and a direction that need the most careful surveillance. In the case where the security camera is mounted to the ceiling, as shown in FIG. 1, a support member 10 is fastened to the ceiling, and a coupling pipe 20 is rotatably coupled to the support member 10, with an electric wire passing through the coupling pipe 20. An upper bracket 30 is attached to the lower end of the coupling pipe 20, and a lower bracket 40 is provided under the upper bracket 30. The upper and lower brackets 30 and 40 are coupled to rotate relative to each other. Arc-shaped guide grooves are formed in opposite sides of the upper bracket 30, each guide groove having a rotating shaft at a center thereof. Thus, with the lower bracket 40 rotating along the guide grooves, the lower bracket 40 may be secured using fastening screws. The lower part of a camera housing and the lower bracket 40 are screwed to each other such that the camera housing is disposed in a rectangular space defined by the lower bracket 40 and the upper bracket 30. The camera housing comprises an upper housing 50 and a lower housing 60. A connection member is fitted into a lower portion inside the lower housing 60 so as to connect all of the lower bracket 40, the lower housing 60, and the lower side of a security camera C to each other. With the camera C secured to the lower housing 60, it is covered by the upper housing 50 and then is secured at opposite sides thereof by fastening screws.

In the case of mounting the security camera on a sidewall, as shown in FIG. 2, a support member 10 is fastened to the sidewall, a mounting plate 20′ is provided on the front end of the support member 10, and a camera housing accommodating the security camera C therein is rotatably positioned above the mounting plate 20′. The camera housing comprises an upper housing 50 and a lower housing 60, so that the upper and lower housings 50 and 60 are connected at predetermined portions on opposite sides thereof by means of fastening screws 61. An upper rotary part 30′ and a lower rotary part 40′ are provided between the bottom of the lower housing 60 and the mounting plate 20′ in such a way as to rotate in a vertical direction. Also, the bottom of the lower rotary part 40′ and the mounting plate 20′ are rotatably coupled to each other.

Further, a connection member is fitted into a lower portion inside the lower housing 60 so as to connect all of the upper rotary part 30′, the lower housing 60, and the lower side of the security camera C to each other. With the camera C secured to the lower housing 60, it is covered by the upper housing 50 and then is secured at opposite sides thereof by fastening screws.

Thus, in the aforesaid general mounting structure for the security camera, it is possible to adjust the tilt angle and the planar rotation angle of the security camera C. However, when a user desires to adjust the frontal rotation angle of the security camera C, that is, the rotation angle of the security camera C itself, no structure for adjusting this rotation angle is provided, so that there is never a method that adjusts the rotation angle. Further, a cable is exposed to the outside, so that an invader may cut the exposed cable, and thus the function of the camera may be lost.

Meanwhile, in order to solve the aforesaid problems, as shown in FIG. 3, a coupling means S for coupling a security camera C with a mounting plate T may be coupled to the mounting plate T, and then the mounting plate T may be fastened to a wall or ceiling. However, this makes the use of a tool H inconvenient, so that installation work requires a long time. Further, bolts and screws cannot be completely tightened, so that the fastening force is not strong, and thereby the camera may fall and break, after a long time has passed and the fastening means (bolts and screws) become loose.

Further, the fastening means (bolts and screws) securing the mounting plate T to the wall or ceiling are exposed to the outside (frontal direction), so that it is poor in appearance and an invader may loosen the fastening means (bolts and screws) to eliminate the function of the camera.

### SUMMARY OF THE INVENTION

Accordingly, the present invention has been made keeping in mind the above problems occurring in the prior art, and an object of the present invention is to provide a mounting device for a security camera, wherein a mounting plate is first fastened and then a main body is installed when the security camera is mounted to the wall or ceiling of a building, thus enabling the security camera to be easily and conveniently mounted, and fastening means (bolts and screws) are not exposed to the outside (frontal direction), thus providing a good appearance, and preventing the camera from falling down to the bottom even though the fastening means (bolts and screws) become loose, therefore preventing the camera from being broken.

In order to accomplish the above object, the present invention provides a mounting device for a security camera, including a mounting plate means including a mounting plate which has a plurality of mounting holes to mount the mounting plate means to a wall, and a pocket part which is integrally provided on a predetermined portion of the mounting plate and has an insert space; and a cover means including a body which has on a central portion thereof a coupling sleeve, with a camera coupling means being coupled to the coupling sleeve, and an insert part which is integrally provided on the body and fitted into the insert space.

A mounting hole located at an uppermost position may have a shape of [symbol] and a drain hole may be formed in a bottom of the pocket part.

A coupling piece may be integrally provided on the bottom of the pocket part and fitted into a coupling hole of the cover means. A drain recess may be provided on the insert part of the body.

A step may be provided on the insert part of the body to allow the pocket part and the body to be on the same plane when the mounting plate means is coupled with the cover means.

A groove may be provided to prevent the insert part fitted into the pocket part from being caught by a bolt and a screw when the mounting plate means is secured to a wall or ceiling using the bolt and the screw.

Further, fastening holes having a common center may be formed, respectively, in the pocket part and the insert part. The mounting device may further include sticker means on which a marker is indicated, a center of the marker being aligned with a center of a corresponding mounting hole before the mounting plate means is secured to the wall or ceiling.

### BRIEF DESCRIPTION OF THE DRAWINGS

The above and other objects, features and advantages of the present invention will be more clearly understood from the following detailed description taken in conjunction with the accompanying drawings, in which:

FIGS. 1 and 2 are perspective views showing conventional mounting structures for security cameras;

FIG. 3 is a sectional view showing another mounting structure for a security camera;

FIG. 4 is a perspective view showing the structure of a mounting device for a security camera according to an embodiment of the present invention;

FIG. 5 is an exploded perspective view showing the structure of the mounting device for the security camera according to the present invention;

FIG. 6 is a sectional view showing the structure of the mounting device for the security camera according to the present invention;

FIG. 7 is a sectional view showing the state in which a coupling piece of a pocket part that is the important part of the present invention is fitted into a coupling hole of a cover means;

FIG. 8 is a perspective view showing a coupling structure of the cover means that is the important part of the present invention with a mounting plate means;

FIG. 9 is a view illustrating a method of installing the mounting device for the security camera according to the present invention;

FIG. 10 is a view illustrating another method of installing the mounting device for the security camera according to the present invention; and

FIG. 11 is an exploded perspective view showing the structure of a mounting device for a security camera according to another embodiment of the present invention.

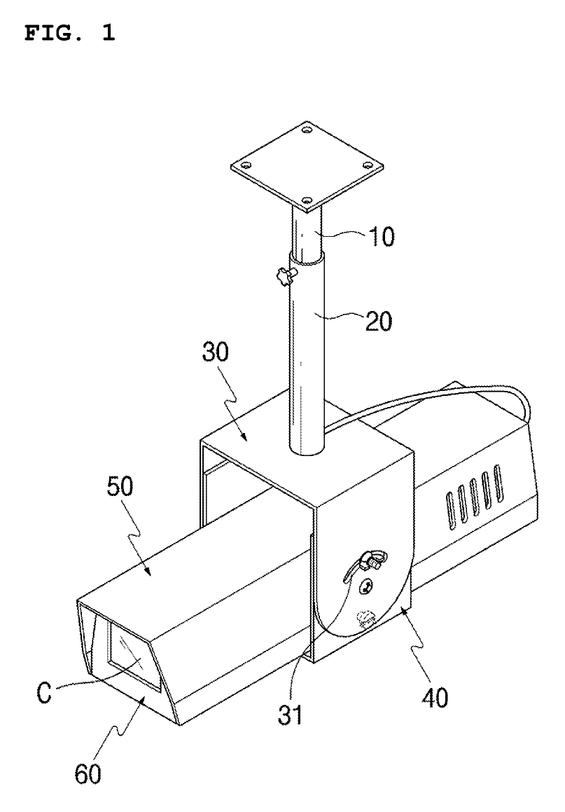

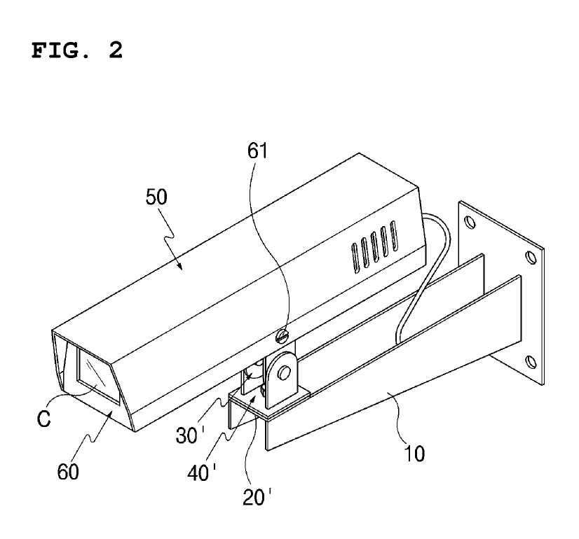

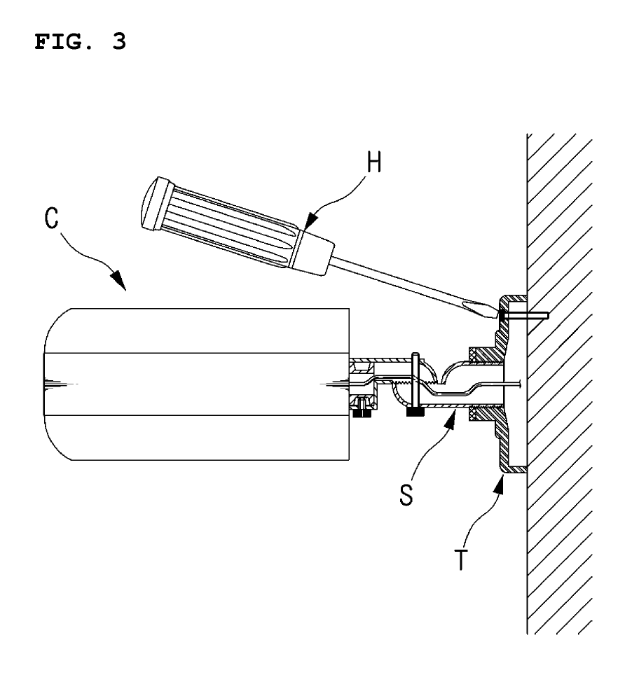

### DESCRIPTION OF THE PREFERRED EMBODIMENTS

Hereinafter, the preferred embodiments of the present invention will be described in detail with reference to the accompanying drawings.

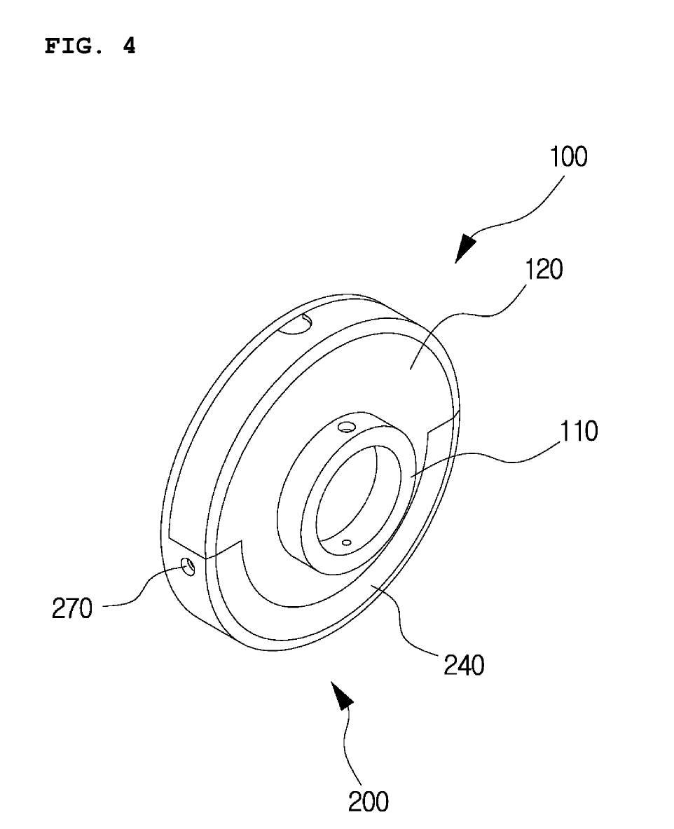

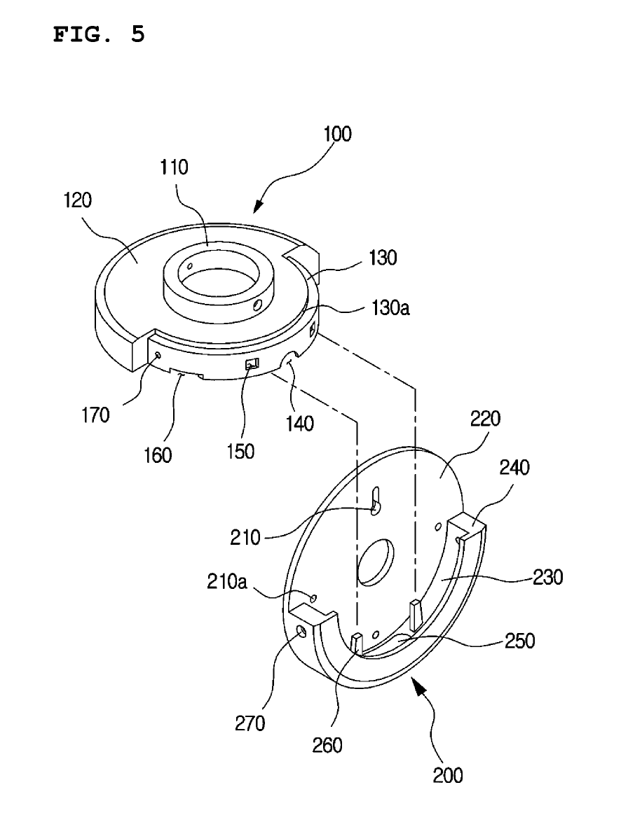

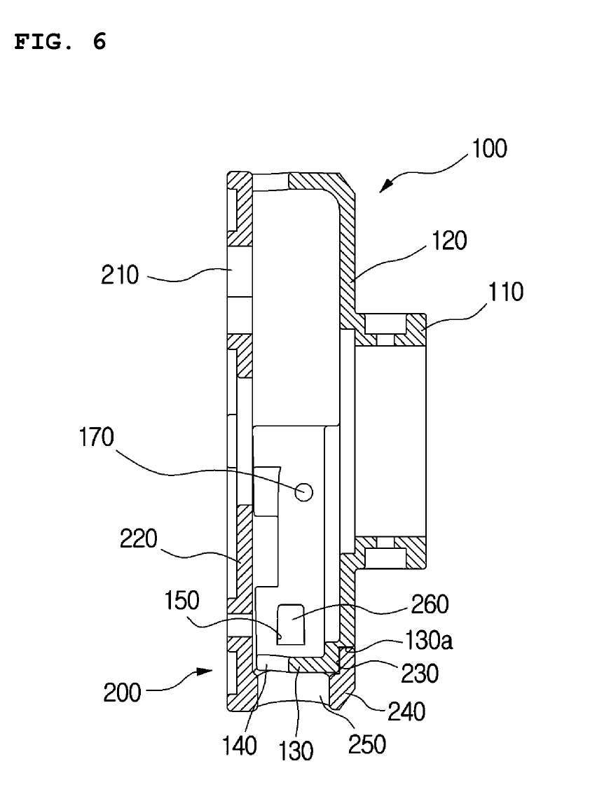

FIG. 4 is a perspective view showing the structure of a mounting device for a security camera according to an embodiment of the present invention, FIG. 5 is an exploded perspective view showing the structure of the mounting device for the security camera according to the present invention, and FIG. 6 is a sectional view showing the structure of the mounting device for the security camera according to the present invention. Referring to the drawings, the mounting device for the security camera C according to the present invention includes a mounting plate means 200 and a cover means 100. The mounting plate means 200 includes a mounting plate 220. A plurality of mounting holes 210 and 210a is provided at regular intervals on the mounting plate 220 and used to mount the mounting plate means 200 to a wall. A pocket part 240 having an insert space 230 is integrally provided on a predetermined portion of the mounting plate 220. The cover means 100 includes a body 120 having on a central portion thereof a coupling sleeve 110, so that a camera coupling means is coupled to the coupling sleeve 110. An insert part 130 which is to be fitted into the insert space 230 is integrally provided on the body 120.

Among the mounting holes 210 and 210a, the mounting hole 210 located at the uppermost position preferably has the shape of [symbol] The reason is for a simple installation. That is, fastening means (bolt and screw) are first installed, and then the mounting plate means 200 is temporarily installed using the [symbol] -shaped mounting hole 210. Thereafter, the fastening means (bolt and screw) are inserted into the remaining mounting holes 210a. In this way, the mounting plate means 200 can be simply installed.

On the one hand, a drain hole 250 is preferably formed in the bottom of the pocket part 240. The reason is as follows. That is, when the security camera C is installed in a building, moisture such as rainwater will hardly at all enter the security camera C. However, if the security camera C is installed to the outside, rainwater may enter the security camera C. Thus, the drain hole 250 formed in the bottom of the pocket part 240 serves to drain the rainwater.

Preferably, a drain recess 140 is formed in the insert part 130 of the body 120. The drain recess 140 prevents the insert part 130 of the cover means 100 from blocking the drain hole 250 when the mounting plate means 200 is coupled with the cover means 100. Further, the drain recess 140 and the drain hole 250 are used even when a cable inevitably enters from the exterior to the camera.

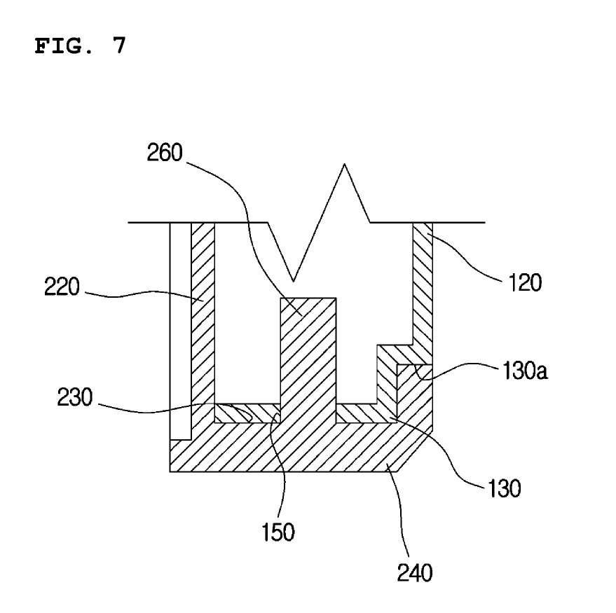

As shown in FIGS. 5 to 7, coupling pieces 260 are integrally provided on the bottom of the pocket part 240 and are fitted into coupling holes 150 of the cover means 100, thus positioning the cover means 100 when the cover means 100 is inserted into the mounting plate means 200, and preventing the cover means 100 from shaking, in addition to preventing the cover means 100 from being undesirably separated from the pocket part 240. Therefore, this prevents the camera from falling down to the bottom even if the fastening means (bolt and screw) are loosened, thus preventing the camera from being broken.

A step 130a is provided on a junction between the body 120 and the insert part 130 to be lower than the body 120. Such a construction allows the pocket part 240 and the body 120 to be on the same plane when the mounting plate means 200 and the cover means 100 are coupled with each other. Meanwhile, the step 130a also functions to prevent the camera from falling down to the bottom even if the fastening means (bolt and screw) become loose.

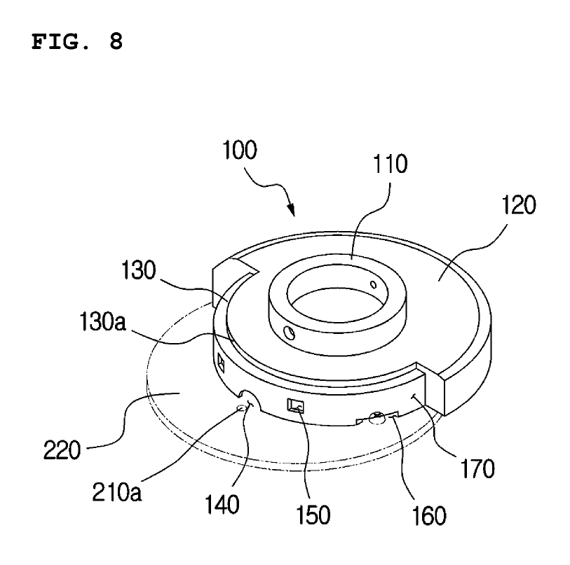

As shown in FIG. 8, when the mounting plate means 200 is secured to the wall or ceiling using bolts and screws, a groove 160 prevents the insert part 130 fitted into the insert space 230 of the pocket part 240 from being caught by the bolts and screws. The groove 160 functions to prevent the mounting plate means 200 from being spaced apart from the cover means 100 when they are coupled to each other.

Meanwhile, when the security camera C is mounted to the wall or ceiling of the building, the mounting plate means 200 is first mounted, and then the cover means 100 is fitted into the mounting plate means 200. This enables easy and convenient installation. Fastening holes 170 and 270 having the common center are formed, respectively, in the side surfaces of the pocket part 240 and the insert part 130, thus preventing the mounting plate means 200 and the cover means 100 from being separated from each other.

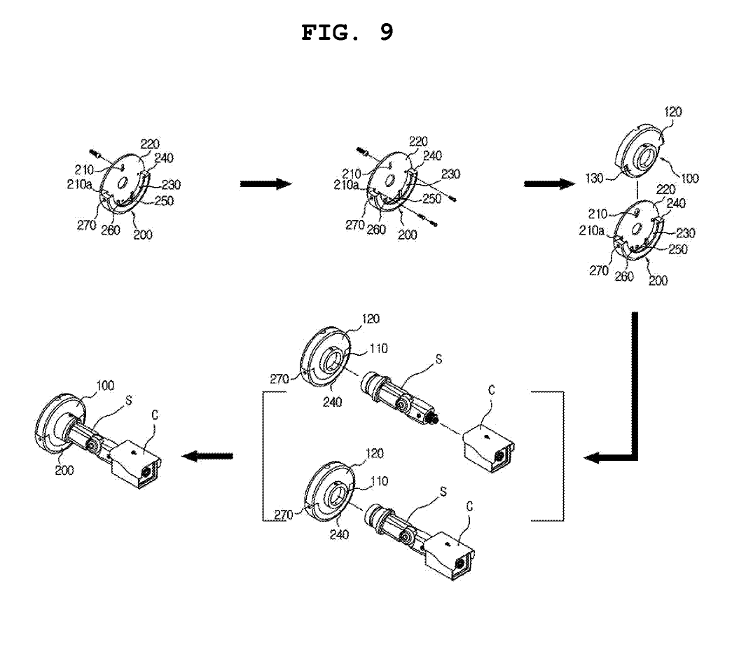

The method of installing the security camera C using the mounting device of the present invention will be described below. As shown in FIG. 9, the fastening means (bolts and screws) are first installed, and then the mounting plate means 200 is temporarily installed using the [symbol] -shaped mounting hole 210. Next, the fastening means (bolt and screw) are inserted into the remaining mounting holes 210a.

The insert part 130 of the cover means 100 is inserted into the insert space 230 defined in the pocket part 240 of the mounting plate means 200 mounted to the wall or ceiling. Thereafter, the camera coupling member S or the camera coupling member S which is equipped with the security camera C is coupled to the coupling sleeve 110 of the cover means 100. Although not shown in the drawings, after the camera coupling member S equipped with the security camera C is previously coupled to the cover means 100, the cover means 100 may be inserted into the pocket part 240 of the mounting plate means 200 to be coupled thereto.

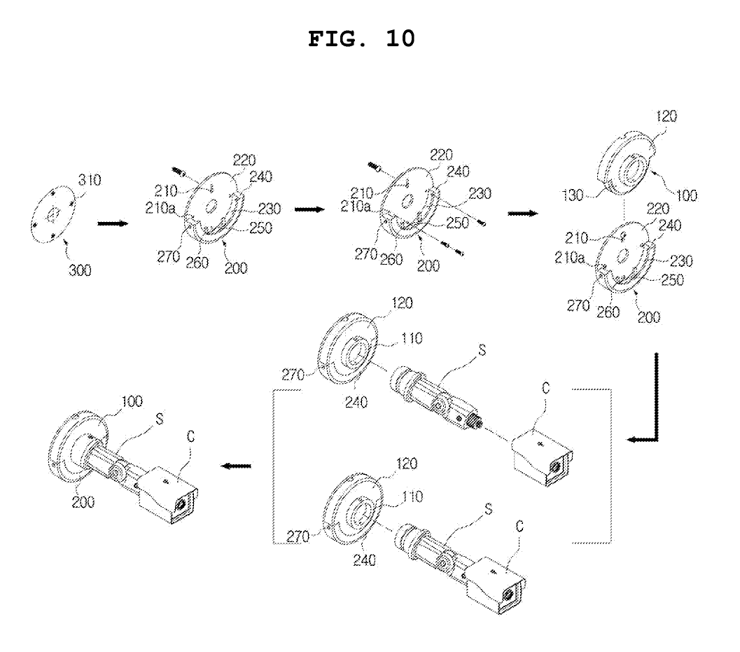

Further, as shown in FIG. 10, before the mounting plate means 200 is mounted to the wall or ceiling, the security camera C can be easily and conveniently installed by using a sticker means 300 having a marker 310 which corresponds to the center of each mounting hole 210 or 210a.

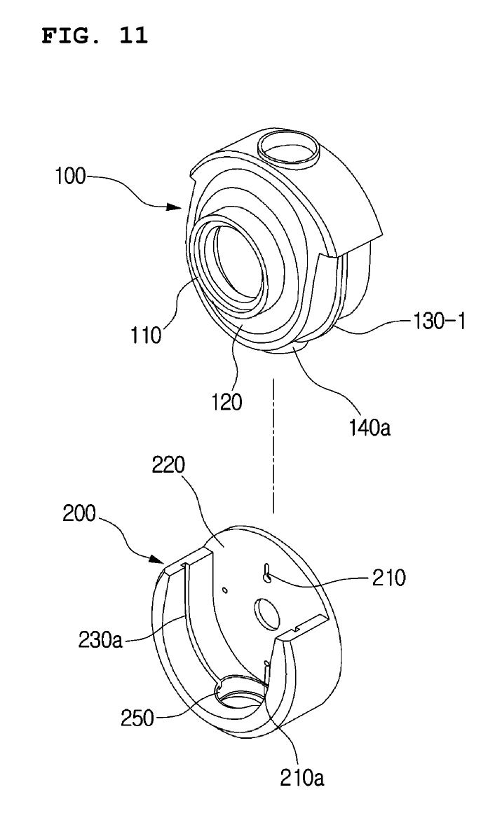

FIG. 11 is an exploded perspective view illustrating another embodiment of the present invention. Referring to the drawing, a coupling protrusion 140a may be integrally provided on the cover means 100 to be fitted into the drain hole 250 which is formed in the bottom of the pocket part 240.

When the mounting plate means 200 is coupled to the cover means 100, the coupling protrusion 140a prevents the insert part 130 of the cover means 100 from blocking the drain hole 250. Further, the coupling protrusion is used even when a cable inevitably enters from the exterior to the camera.

Further, a protruding rim 130-1 may be provided on the insert part 130 of the cover means 100. The pocket part 240 of the mounting plate means 200 may further include a groove 240a so that protruding rim 130-1 is fitted into the groove 240a.

As described above, the present invention provides a mounting device for a security camera, wherein a mounting plate is first fastened and then a main body is installed when the security camera is mounted to the wall or ceiling of a building, thus enabling the security camera to be easily and conveniently mounted, and fastening means (bolts and screws) are not exposed to the outside (frontal direction), thus providing a good appearance, and preventing the camera from falling down to the bottom even though the fastening means (bolts and screws) become loose, therefore preventing the camera from being broken.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A mounting device for a security camera, comprising:
mounting plate means comprising:
a mounting plate having a plurality of mounting holes provided at regular intervals thereon to mount the mounting plate means to a wall; and
a pocket part integrally provided on a predetermined portion of the mounting plate, and having an insert space; and
cover means comprising:
a body having on a central portion thereof a coupling sleeve, with camera coupling means being coupled to the coupling sleeve; and
an insert part integrally provided on the body, and fitted into the insert space.

2. The mounting device as set forth in claim 1, wherein a mounting hole located at an uppermost position has a shape of

[symbol]

3. The mounting device as set forth in claim 1, wherein a drain hole is formed in a bottom of the pocket part.

4. The mounting device as set forth in claim 1, wherein a coupling piece is integrally provided on the bottom of the pocket part and is fitted into a coupling hole of the cover means.

5. The mounting device as set forth in claim 1, wherein a step is provided on the insert part of the body to allow the pocket part and the body to be on the same plane when the mounting plate means is coupled with the cover means.

6. The mounting device as set forth in claim 1, wherein a drain recess is provided on the insert part of the body.

7. The mounting device as set forth in claim 1, wherein a groove is provided to prevent the insert part fitted into the pocket part from being caught by a bolt and a screw when the mounting plate means is secured to a wall or ceiling using the bolt and the screw.

8. The mounting device as set forth in claim 1, wherein fastening holes having a common center are formed, respectively, in side surfaces of the pocket part and the insert part.

9. The mounting device as set forth in claim 1, further comprising:
sticker means on which a marker is indicated, a center of the marker being aligned with a center of a corresponding mounting hole before the mounting plate means is secured to the wall or ceiling.

10. The mounting device as set forth in claim 1, wherein a coupling protrusion is integrally provided on the cover means and is fitted into the drain hole formed in the bottom of the pocket part.

11. The mounting device as set forth in claim 1, wherein a protruding rim is provided on the insert part of the body, and a groove is provided on the pocket part of the mounting plate means so that the protruding rim is fitted into the groove.

12. A method for mounting a security camera, comprising:
fastening mounting plate means to a wall, the mounting plate means including a mounting plate having a plurality of mounting holes provided at regular intervals thereon to mount the mounting plate means to the wall, and a pocket part integrally provided on a predetermined portion of the mounting plate and having an insert space; and
fitting cover means into the mounting plate means in a direction from an upper position to a lower position, the cover means including a body having on a central portion thereof a coupling sleeve, with camera coupling means being coupled to the coupling sleeve, and an insert part integrally provided on the body and fitted into the insert space.
